(19) United States
(12) Patent Application Publication
(10) Pub. No.: US 2020/0071450 A1
(43) Pub. Date: Mar. 5, 2020

(54) IN-SITU WEIGHTING AGENT/PIGMENT SETTLING CONTROL AGENT

(71) Applicant: COVESTRO LLC, Pittsburgh, PA (US)

(72) Inventor: David P. Zielinski, Cranberry Township, PA (US)

(21) Appl. No.: 16/118,963

(22) Filed: Aug. 31, 2018

(51) Int. Cl. C08G 18/62; C08G 18/44; C08G 18/73; C08G 18/76; C08K 3/013; C08K 3/30; C08K 5/00; C08K 5/18; C08K 5/29

(52) U.S. Cl. CPC C08G 18/6254; C08G 18/44; C08G 18/735; C08G 18/7621; C08G 18/7678; C08K 2003/3045; C08K 3/30; C08K 5/0041; C08K 5/18; C08K 5/29; C08K 3/013

(57) ABSTRACT

The present invention provides a formulation comprising: a) a polyol-containing component; b) a weighting agent or a pigment; c) an anti-settling agent selected from the group consisting of primary amines and secondary amines; and d) a polyisocyanate-containing component, wherein the anti-settling agent reduces foam formation during mixing of the formulation as compared to the formulation not containing the anti-settling agent. The formulation may provide improved drilling fluids, coatings, sealants, adhesives, composites, and films.

### FIELD OF THE INVENTION

The present invention relates in general to oil and gas recovery, and more specifically, to primary or secondary amine anti-settling agents that reduce settling of weighting agents or pigments used in polyisocyanate-containing formulations.

### BACKGROUND OF THE INVENTION

The recovery of resources, such as natural gas or oil, from an underground formation typically entails drilling a wellbore to the formation while circulating a drilling fluid, such as a water-based or oil-based drilling mud, within the wellbore. After the wellbore is drilled and completed, these resources are recovered over a period of time at a rate that is inconsistent and that diminishes over time. This general loss of production over time can be mitigated by a process called “re-fracturing” or “refracing”. The concept of refracturing oil and gas wells is not new. It has been done since the 1970's in vertical wells and currently is being used to a limited degree in horizontal wells. The balance of protecting the oil and gas well while re-energizing it through refracturing is the focus of much activity in the oil and gas market.

To refac a well, one must isolate the old fractures (called zonal isolation) because those fractures may act as pressure relief areas during the next fracturing process. The formation can be irreparably damaged by furthering the current fractures into non-productive rock strata or into formations that will collapse or allow an influx of formation water into the wellbore. This isolation can be accomplished by various means; either mechanically or chemically.

Synthetic polymers, such as polyurethanes, have been proposed as a potential lost circulation materials (LCM) in oil and gas recovery. These same materials are proposed to act as zonal isolation agents as well. Lost circulation materials frequently include weighting agents such as barite which are prone to settle out of the fluid. Typically, suspending agents have been used to prevent such settling. Suspending agents that have been used in drilling fluids include organophilic clays, amine-treated clays, oil soluble polymers, polyamide resins, polycarboxylic acids, fumed silica, and soaps. The amounts of such conventional suspending agents used varies depending upon the end use of the composition.

A problem with using these conventional means of preventing the settling of a weighting agents such as barite by using fumed silica is that it leads to foaming during mixing. Although many drillers find foaming to be an unacceptable condition, without an “anti-settling” agent, the zonal isolation agent will stratify, which can lead to loss of zonal isolation agent density and consistency during application. A suitable replacement for the state of the art anti-settling agents such as fumed silica is needed.

As a result, it would be desirable to provide improved zonal isolation agents that will reduce both striation and foaming caused by conventional anti-settling agents.

### SUMMARY OF THE INVENTION

Accordingly, the present invention alleviates problems inherent in the art by providing a formulation comprising: a) a polyol-containing component; b) a weighting agent or a pigment; c) an anti-settling agent selected from the group consisting of primary amines and secondary amines; and d) a polyisocyanate-containing component, wherein the anti-settling agent reduces foam formation during mixing of the formulation as compared to the formulation not containing the anti-settling agent. The formulation may provide improved drilling fluids, coatings, sealants, adhesives, composites, and films.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 is a photograph of the formulations of Ex. 1, Ex. 2, Ex. 3, and Ex. 4, all after 16 hours at 120′F (48.9° C.);

FIG. 2 is a photograph showing initial views of the formulations of Ex. 5, Ex. 6, Ex. 7, Ex. 8, and Ex. 9;

FIG. 3 is a photograph showing the formulations of Ex. 5, Ex. 6, Ex. 7, Ex. 8, and Ex. 9, all after two hours at 120° F. (48.9° C.); and

FIG. 4 is a photograph showing the formulations of Ex. 5, Ex. 6, Ex. 7, Ex. 8, and Ex. 9, all after 16 hours at 120° F. (48.9° C.).

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In one aspect, the present invention is directed to a formulation comprising: a) a polyol-containing component; b) a weighting agent or a pigment; c) an anti-settling agent selected from the group consisting of primary amines and secondary amines; and d) a polyisocyanate-containing component, wherein the anti-settling agent reduces foam formation during mixing of the formulation as compared to the formulation not containing the anti-settling agent. The formulation may provide improved drilling fluids, coatings, sealants, adhesives, composites, and films because the anti-settling agent reduces both-stratification and foaming seen during mixing with conventional anti-settling agents.

In another aspect, the present invention is directed to a method of reducing foaming of a formulation, the method comprising: a) preparing a formulation by combining, (1) a polyol-containing component, (2) a weighting agent or a pigment, (3) an anti-settling agent selected from the group consisting of primary amines and secondary amines, and (4) a polyisocyanate-containing component; and b) mixing the formulation, wherein the anti-settling agent reduces foaming during mixing as compared to the formulation not containing the anti-settling agent.

In yet another aspect, the present invention is directed to a method of treating an underground geologic formation comprising: (a) introducing a formulation comprising: a) a polyol-containing component; b) a weighting agent or a pigment; c) an anti-settling agent selected from the group consisting of primary amines and secondary amines; and d) a polyisocyanate-containing component, into the formation; (b) forcing the formulation into pores of the formation under sufficient pressure and for a sufficient time such that the polyol-containing component and the polyisocyanate-containing component react to form a solid polyurethane reaction product that seals the existing perforations and associated fractures of the formation to reduce or prevent water ingress; and (c) forcing a slurry comprising a plurality of proppant particles suspended in a carrier fluid into the formation under sufficient pressure and for a sufficient time such that new fissures and cracks are formed in the formation.

In still another aspect, the present invention is directed to an oil and gas well treatment comprising: introducing a formulation comprising: a) a polyol-containing component; b) a weighting agent or a pigment; c) an anti-settling agent selected from the group consisting of primary amines and secondary amines; and d) a polyisocyanate-containing component into a well bore, wherein the formulation solidifies and reduces or prevents ingress of formation water into the oil and gas well.

As used herein, the term, “formulation” refers to a mixture prepared according to a particular formula.

As used herein, the terms “drilling fluid” and “drilling mud” refer to a heavy, viscous fluid mixture used in oil and gas drilling operations to carry rock cuttings to the surface and to lubricate and cool the drill bit. Drilling fluid acts by hydrostatic pressure to prevent collapse of unstable strata into the borehole and intrusion of water from water-bearing strata that may be encountered during oil and gas drilling operations.

As used herein, the term “lost circulation material (LCM)” refers to substances which are added to drilling fluids to reduce the loss of drilling fluids in downhole formations. Conventional lost-circulation materials (LCM) include fibrous materials, e.g., cedar bark, shredded cane stalks, mineral fiber and hair; flaky materials, e.g., mica flakes and pieces of plastic sheeting; and granular materials, e.g., ground and sized limestone or marble, wood, nut hulls, FORMICA, corn cobs, and cotton hulls.

As used herein, the term “coating composition” refers to a mixture of chemical components that will cure and form a coating when applied to a substrate.

The terms “adhesive” or “adhesive compound”, refer to any substance that can adhere or bond two items together. Implicit in the definition of an “adhesive composition” or “adhesive formulation” is the concept that the composition or formulation is a combination or mixture of more than one species, component or compound, which can include adhesive monomers, oligomers, and polymers along with other materials.

A “sealant composition” refers to a composition which may be applied to one or more surfaces to form a protective barrier, for example to prevent ingress or egress of solid, liquid or gaseous material or alternatively to allow selective permeability through the barrier to gas and liquid. In particular, it may provide a seal between surfaces.

A “casting composition” refers to a mixture of liquid chemical components which is usually poured into a mold containing a hollow cavity of the desired shape, and then allowed to solidify.

A “composite” refers to a material made from two or more polymers, optionally containing other kinds of materials. A composite has different properties from those of the individual polymers/materials which make it up.

“Cured,” “cured composition” or “cured compound” refers to components and mixtures obtained from reactive curable original compound(s) or mixture(s) thereof which have undergone chemical and/or physical changes such that the original compound(s) or mixture(s) is(are) transformed into a solid, substantially non-flowing material. A typical curing process may involve crosslinking.

The term “curable” means that an original compound(s) or composition material(s) can be transformed into a solid, substantially non-flowing material by means of chemical reaction, crosslinking, radiation crosslinking, or the like. Thus, compositions of the invention are curable, but unless otherwise specified, the original compound(s) or composition material(s) or formulations is(are) not cured.

As used herein, the term “polyisocyanate” refers to compounds comprising at least two free isocyanate groups. Polyisocyanates include diisocyanates and diisocyanate reaction products comprising, for example, biuret, isocyanurate, uretdione, urethane, urea, iminooxadiazine dione, oxadiazine trione, carbodiimide, acyl urea, and/or allophanate groups.

Suitable polyisocyanates include, but are not limited to, aromatic, araliphatic, aliphatic and cycloaliphatic polyisocyanates, such as, for example, ethylene diisocyanate; 1,4-tetramethylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, benzene diisocyanate; 1,4-cyclohexylene diisocyanate, 1,12-dodecamethylene diisocyanate, 1,4-phenylene diisocyanate, 2,4- and/or 2,6-toluene diisocyanate (TDI) or hydrogenated 2,4- and/or 2,6-toluene diisocyanate, 1,5-naphthalene diisocyanate, 2,4′- and 4,4′-diphenylmethane diisocyanate (MDI), 1,3- and 1,4-bis-(2-isocyanato-prop-2-yl)-benzene (TMXDI), 1,3-bis(isocyanato-methyl)benzene (XDI), bis-(4-isocyanato-cyclohexyl)methane (H12MDI), (S)-alkyl 2,6-diisocyanato-hexanoates or (L)-alkyl 2,6-diisocyanatohexanoates. In various embodiments, the polyisocyanate component may comprise a triisocyanate, such as, for example, 4-isocyanatomethyl-1,8-octane diisocyanate (triisocyanatononane or TIN); isomers thereof; or derivatives thereof. A specific example of a (cyclo)aliphatic polyisocyanate polymer suitable for use in the formulation of the present invention is DESMODUR XP 2580, from Covestro LLC.

Additional polyisocyanates (including various diisocyanates) that may also find utility in the present invention may include the polyisocyanates described in U.S. Pat. Nos. 5,075,370; 5,304,400; 5,252,696; 5,750,613; and 7,205,356, each of which is incorporated by reference herein. Combinations of any of the above-identified and incorporated polyisocyanates may also be used to form a polyurethane dispersion useful herein.

The di- and tri-isocyanates indicated may be used as such, or as derivative polyisocyanates comprising biuret, isocyanurate, uretdione, urethane, urea, iminooxadiazine dione, oxadiazine trione, carbodiimide, acyl urea, and/or allophanate groups. In various embodiments, derivative polyisocyanates comprising biuret, isocyanurate, uretdione, urethane, iminooxadiazine dione, oxadiazine trione, carbodiimide, acyl urea, and/or allophanate groups are included in the polyisocyanate coating. In various embodiments, the polyisocyanate component comprises one or more of the above-identified structural groups prepared from IPDI, HDI, H12MDI, and/or cyclohexane 1,4-diisocyanate.

Polyisocyanates may also be covalently modified with ionic or potentially ionic internal emulsifying groups to form hydrophilically-modified water-dispersible polyisocyanates. The ionic or potentially ionic groups may be cationic or anionic. As used herein, the term “ionic or potentially ionic group” refers to a chemical group that is nonionic under certain conditions and ionic under certain other conditions. For example, in various embodiments, the ionic group or potentially ionic group may comprise a carboxylic acid group; a carboxylate group; a sulfonic acid group; a sulfonate group; a phosphonic acid group; a phosphonate group; or combinations of any thereof. In this regard, for example, carboxylic acid groups, sulfonic acid groups, and phosphonic acid groups are potentially ionic groups, whereas, carboxylate groups, sulfonate groups, and phosphonate groups are ionic groups in the form of a salt, such as, for example, a sodium salt.

For example, carboxylate (carboxylic acid) groups, sulfonate (sulfonic acid) groups, or phosphonate (phosphonic acid) groups may be covalently introduced into polyisocyanates to form hydrophilically-modified water-dispersible polyisocyanates. The ionic or potentially ionic groups may be introduced through a reaction between the isocyanate groups of the polyisocyanate and less than stoichiometric amounts of amino-functional or hydroxy-functional carboxylic acids, sulfonic acids, phosphonic acids, or salts thereof. Examples include, but are not limited to dimethylolpropionic acid (DMPA), N-(2-aminoethyl)-2-aminoethane sulfonic acid (AAS); N-(2-aminoethyl)-2-aminopropionic acid; 2-(cyclohexyl-amino)-ethane sulfonic acid; 3-(cyclohexyl-amino)-1-propane sulfonic acid (CAPS); 2-aminoethylphosphonic acid; or the salts thereof.

If free carboxylic acids, sulfonic acids, or phosphonic acids are incorporated in the polyisocyanate, then the acids may be neutralized with a neutralizing agent, such as, for example, tertiary amines, including, but not limited to, trialkyl-substituted tertiary amines. The preparation of hydrophilically-modified water-dispersible polyisocyanates is described, for example, in U.S. Pat. No. 6,767,958, which is incorporated by reference herein. Water-dispersible polyisocyanate mixtures based on triisocyanatononane (TIN) are described in WO2001/062819, which is incorporated by reference herein.

The polyisocyanates may also be partially blocked with compounds that are reversibly reactive with isocyanate groups. Suitable blocking agents for polyisocyanates include, for example, monohydric alcohols such as methanol, ethanol, butanol, hexanol, cyclohexanol, benzyl alcohol, oximes such as acetoxime, methyl ethyl ketoxime, cyclohexanone oxime, lactams such as c caprolactam, phenols, amines such as diisopropylamine or dibutylamine, dimethylpyrazole or triazole, as well as malonic acid dimethyl ester, malonic acid diethyl ester or malonic acid dibutyl ester.

As used herein, the term “polyol” refers to compounds comprising at least two free hydroxy groups. Polyols include polymers comprising pendant and/or terminal hydroxy groups.

Polymeric polyols have a molecular weight Mₙ of from 400 to 8000 g/mol, such as 400 to 6000 g/mol or, in some cases, 500 to 3000 g/mol, 1000 to 3000 g/mol or 1500 to 3000 g/mol. In certain embodiments, these polymeric polyols have a hydroxyl number of from 20 to 400 mg KOH/g of substance, such as 20 to 300 mg KOH/g of substance, 20 to 200 mg KOH/g of substance or 20 to 100 mg KOH/g of substance. In certain embodiments, these polymeric polyols have a hydroxyl functionality of 1.5 to 6, such as 1.8 to 3 or 1.9 to 2.1. As will be appreciated, the Mₙ of a polymer containing functional groups, such as a polyol, can, as discussed earlier, be calculated from the functional group number, such as hydroxyl number, which is determined by end-group analysis. “Hydroxyl number”, as used herein, is determined according to DIN 53240.

Polymeric polyols suitable for use in the present invention are commercially available and include, but are not limited to, those commercially available from Covestro LLC under the names MULTRANOL 4011, MULTRANOL 4012, MULTRANOL 4035, MULTRANOL 9158, MULTRANOL 9198, ARCOL PPG425, ARCOL 700, and ARCOL LHT 240.

Exemplary polymeric polyols include, for example, polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, polyester polycarbonate polyols, phenol/formaldehyde resins, on their own or in mixtures.

Suitable polyether polyols include, for example, the polyaddition products of the styrene oxides, of ethylene oxide, propylene oxide, tetrahydrofuran, butylene oxide, epichlorohydrin, as well as their mixed-addition and graft products, as well as the polyether polyols obtained by condensation of polyhydric alcohols or mixtures thereof and those obtained by alkoxylation of polyhydric alcohols, amines and amino alcohols.

Suitable polyether polyols often have a hydroxyl functionality of 1.5 to 6.0, such as 1.8 to 3.0, a hydroxyl number of 20 to 700 mg KOH/g solid, such as 20 to 100, 20 to 50 or, in some cases 20 to 40 mg KOH/g solid, and/or a Mn of 400 to 4000 g/mol, such as 100 to 4000 or 1000 to 3000 g/mol.

Exemplary polyester polyols are the polycondensation products of di- as well as optionally tri- and tetra-ols and di- as well as optionally tri- and tetra-carboxylic acids or hydroxycarboxylic acids or lactones. Instead of the free polycarboxylic acids it is also possible to use the corresponding polycarboxylic acid anhydrides or corresponding polycarboxylic acid esters of lower alcohols to prepare the polyesters. Examples of suitable diols are ethylene glycol, butylene glycol, diethylene glycol, triethylene glycol, polyalkylene glycols such as polyethylene glycol, further 1,2-propanediol, 1,3-propanediol, 1,3-butanediol, 1,4-butanediol, 1,6-hexanediol and isomers, 1,8-octanediol, neopentyl glycol, 1,4-bishydroxymethyl-cyclohexane, 2-methyl-1,3-propanediol, 2,2,4-trimethyl-1,3-pentanediol, dipropylene glycol, polypropylene glycols, dibutylene glycol, polybutylene glycols, bisphenol A, tetrabromobisphenol A, lactone-modified diols, or hydroxypivalic acid neopentyl glycol ester. In order to achieve a functionality >2, polyols having a functionality of 3 can optionally be used proportionately, for example trimethylolpropane, glycerol, erythritol, pentaerythritol, trimethylolbenzene or trishydroxyethyl isocyanurate.

Suitable dicarboxylic acids are, for example, phthalic acid, isophthalic acid, terephthalic acid, tetrahydrophthalic acid, hexahydro-phthalic acid, cyclohexane-dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, and/or 2,2-dimethylsuccinic acid. Anhydrides of those acids can likewise be used, where they exist. Thus, for the purposes of the present invention, anhydrides are included in the expression “acid”. Monocarboxylic acids, such as benzoic acid and hexanecarboxylic acid, can also be used, provided that the mean functionality of the polyol is 2. Saturated aliphatic or aromatic acids can be used, such as adipic acid or isophthalic acid. Trimellitic acid is a polycarboxylic acid which can also optionally be used.

Hydroxycarboxylic acids which can be used as reactants in the preparation of a polyester polyol having terminal hydroxyl groups are, for example, hydroxycaproic acid, hydroxybutyric acid, hydroxydecanoic acid, hydroxystearic acid and the like. Suitable lactones are, for example, ε-caprolactone, butyrolactone and their homologues.

In certain embodiments of the present invention, a polymer polyol comprises or, in some cases, consists essentially of or consists of a polyester diol that is a reaction product of butanediol and one or more of neopentyl glycol, hexanediol, ethylene glycol, and diethylene glycol with adipic acid and one or more of phthalic acid and isophthalic acid, such as polyester polyols that are a reaction product of at least one of butanediol, neopentyl glycol, and hexanediol with at least one of adipic acid and phthalic acid.

Suitable polyester polyols, such as the foregoing polyester diols, often have a hydroxyl functionality of 1.5 to 6.0, such as 1.8 to 3.0, a hydroxyl number of 20 to 700 mg KOH/gram solid, such as 20 to 100, 20 to 80 or, in some cases 40 to 80 mg KOH/g solid, and/or a Mₙ of 500 to 3000 g/mol, such as 600 to 2500 g/mol.

Exemplary polycarbonate polyols are obtainable by reaction of carbonic acid derivatives, for example diphenyl carbonate, dimethyl carbonate or phosgene, with diols. Suitable diols include the diols mentioned earlier with respect to the preparation of polyester polyols. In some cases, the diol component contains from 40 wt. % to 100 wt. % 1,6-hexanediol and/or hexanediol derivatives, often containing ether or ester groups in addition to terminal OH groups, for example products which are obtained by reaction of one mole of hexanediol with at least one mole, preferably from one to two moles, of ε-caprolactone or by etherification of hexanediol with itself to form di- or tri-hexylene glycol. Polyether polycarbonate polyols can also be used.

In various embodiments, the formulation optionally comprises a urethane-forming catalyst. Examples of such catalysts include, but are not limited to, tertiary amines and metal compounds. Some examples of suitable tertiary amine catalysts include, but are not limited to, triethylamine, tributylamine, N-methylmorpholine, N-ethyl-morpholine, N,N,N′,N′-tetra-methylethylene diamine, pentamethyl-diethylene triamine, and higher homologs, 1,4-diazabicyclo[2.2.2]octane, N-methyl-N′(dimethylaminoethyl) piperazine, bis(dimethylaminoalkyl)-piperazines, N,N-dimethylbenzylamine, N,N-dimethylcyclohexylamine, N,N-diethylbenzylamine, bis(N,N-diethyl-aminoethyl) adipate, N,N,N′,N′-tetramethyl-1,3-butanediamine, N,N-dimethyl-β-phenylethylamine, 1,2-dimethylimidazole, 2-methylimidazole, monocyclic and bicyclic amidines, bis(dialkylamino)alkyl ethers, and tertiary amines containing amide groups (preferably formamide groups). The catalyst used may also be a Mannich base of secondary amines (such as dimethylamine) and aldehydes (preferably formaldehyde) or ketones (such as acetone) and phenols.

In some embodiments, the catalyst comprises an acid blocked amine, i.e., a delayed action amine catalyst. The blocking agent can be an organic carboxylic acid having 1 to 20 carbon atoms, such as 1 to 2 carbon atoms. Examples of blocking agents include 2-ethyl-hexanoic acid and formic acid. Such acid blocked amine catalysts are described in, for example, U.S. Pat. No. 6,013,690. Additional examples of suitable organic acid blocked amine catalysts which may be employed, are the acid blocked amines of triethylene-diamine, N-ethyl or methyl morpholine, N,N dimethylamine, N-ethyl or methyl morpholine, N,N dimethylaminoethyl morpholine, N-butyl-morpholine, N,N′ dimethylpiperazine, bis(dimethylamino-alkyl)-piperazines, 1,2-dimethyl imidazole, dimethyl cyclohexylamine. Further examples include DABCO 8154 catalyst based on 1,4-diazabicyclo[2.2.2]octane, 1,5-Diazabicyclo[4.3.0]non-5-ene, and DABCO BL-17 catalyst based on bis(N,N-dimethylaminoethyl) ether (available from Air Products and Chemicals, Inc., Allentown, Pa.) and POLYCAT SA-1, POLYCAT SA-102, and POLYCAT SA-610/50 catalysts based on POLYCAT DBU amine catalyst (available from Air Products and Chemicals, Inc.) as described in, for example, U.S. Pat. No. 5,973,099. Other acid blocked amine catalysts suitable for the present invention include those described in, for example U.S. Pat. Nos. 4,219,624, 5,112,878, 5,183,583, 5,789,533, 6,395,796, 6,432,864 and 6,525,107.

Other suitable catalysts include organic metal compounds, such as organic tin, bismuth, zinc, lithium, titanium, manganese germanium, cobalt, and/or zirconium compounds. Suitable organic tin compounds include those containing sulfur, such as dioctyl tin mercaptide, and tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutytin maleate, and dioctyltin diacetate. Suitable bismuth compounds include bismuth neodecanoate, bismuth versalate, and various bismuth carboxylates. Suitable zinc compounds include zinc neodecanoate and zinc versalate. Mixed metal salts containing more than one metal (such as carboxylic acid salts containing both zinc and bismuth) are also suitable catalysts.

In some embodiments, the catalyst comprises a delayed action or heat-activated tin catalyst such as, for example, dibutyltin dimercaptide, dibutyltin diisooctylmercaptoacetate, dimethyltin dimercaptide, dibutyltin dilaurylmercaptide, dimethyltin dilaurylmercaptide, dimethyltin dithioglycolate, dimethyltin diisooctylmercaptoacetate, di(n-butyl)tin bis(isooctylmercapto-acetate), and di(isooctyl)tin bis(isooctylmercaptoacetate), all of which are commercially available. The use of other delayed action organic metal catalysts, such as an iron pentanedione or a bismuth carboxylate, is also possible. The use of encapsulated metal catalysts, such as polymer encapsulated tin catalysts, is also suitable.

The quantity of catalyst can vary depending on the specific catalyst used. In some embodiments, the catalyst is used in an amount of up to 5 percent by weight, such as 0.001 to 3 percent by weight, or, in some cases, 0.001 to 2 percent by weight, based on the total weight of the formulation.

Weighting agents increase the density of the drilling fluid without adversely affecting the rheological properties of the system, thereby allowing it to remain pumpable. Such agents are useful in drilling operations to control formation pressures, to prevent formation caving, and to facilitate the pulling of dry pipe. Suitable weighting agents, in the context of the present invention include, but are not limited to, barite (BaSO₄), hematite (Fe₂O₃), siderite (FeCO₃), ilmentite (FeO.TiO₂), magnetite (Fe₃O₄), hausmannite (Mn₃O₄), galena (PbS), calcite (CaCO₃), celestine (SrSO₄), halite (NaCl), and dolomite (CaMg(CO₃)₂).

The quantity of weighting agent added depends upon the desired density of the final formulation. As will be appreciated by one skilled in the art, the amount of weighting agent may be varied depending upon the intended application, such that an effective amount may be selected to provide a desired density for a wellbore drilling fluid. For example, based on 100 pbw water in the drilling fluid, the amount of the weighting agent is preferably 40-200 pbw, more preferably, it is 400-500 pbw.

Any suitable pigment can be used in the present invention. Examples of suitable pigments include inorganic white pigments, inorganic chromatic pigments, iron oxide pigments, oxidic mixed-phase pigments, organic pigments, and inorganic black pigments.

As inorganic white pigments, mention should be made in particular of oxides, such as titanium dioxide, zinc oxide (ZnO, zinc white), zirconium oxide, carbonates such as lead white, sulfates, such as lead sulfate, and sulfides such as zinc sulfide, and lithopones; titanium dioxide is particularly preferred.

As inorganic chromatic pigments, mention should be made of those from the group of oxides and hydroxides in the form of their individual inorganic compounds or mixed phases, especially iron oxide pigments, chromium oxide pigments and oxidic mixed-phase pigments with rutile or spinel structure, and also bismuth vanadate, cadmium, cerium sulfide, chromate, ultramarine and iron blue pigments.

Examples of iron oxide pigments are Color Index Pigment Yellow 42, Pigment Red 101, Pigment Blue 11, Pigment Brown 6, and transparent iron oxide pigments. Examples of chromium oxide pigments are Color Index Pigment Green 17 and Pigment Green 18.

Examples of oxidic mixed-phase pigments are nickel titanium yellow and chromium titanium yellow, cobalt green and cobalt blue, zinc iron brown and chromium iron brown, and also iron manganese black and spinel black.

Examples of preferred organic pigments are those of the monoazo, disazo, laked azo, β-naphthol, Naphiol AS, benzimidazolone, disazo condensation, azo metal complex, isoindoline and isoindolinone series, and also polycyclic pigments such as those from the phthalocyanine, quinacridone, perylene, perinone, thioindigo, anthraquinone, dioxazine, quinophthalone and diketopyrrolopyrrole series. Also suitable are laked dyes such as Ca, Mg and Al lakes of dyes containing sulfonic acid or carboxylic acid groups, and also carbon blacks, which for the purposes of this specification are taken to be pigments and of which a large number are known. Mention should be made in particular of acidic to alkaline carbon blacks obtained by the furnace black process, and also chemically surface-modified carbon blacks, examples being sulfo- or carboxyl-containing carbon blacks.

Examples of inorganic black pigments include those as already described above together with the inorganic chromatic pigments, especially black iron oxide, spinel black, and black oxidic mixed-phase pigments.

In various embodiments, the pigment is present at a level of at least 1%, in some cases at least 2%, in other cases at least 5% by weight of the formulation, in some situations at least 10% and in other situations at least 15% by weight. In certain other embodiments, the pigment is present at a level of up to 60%, in some cases up to 50%, in other cases up to 40%, in some situations up to 35% and in other situations up to 30% by weight, based on the weight of the formulation. The pigment may be present in the formulation of the invention in an amount ranging between any combination of these values, inclusive of the recited values.

Anti-settling agents create highly thixotropic flow behavior and consequently improve the anti-sagging and anti-settling properties of zonal isolation agents. In the context of the present invention, the inventor has surprisingly found that small amounts of primary or secondary amines perform quite well as anti-settling agents. Such primary and secondary amines include, but are not limited to, ethylenediamine, 1,2-propylenediamine, 1,3-propylenediamine, N-methylpropylene-1,3-diamine, N,N′-dimethylethylenediamine, isophoronediamine, 2,4-toluenediamine and 2,6-toluenediamine, 3,5-diethyl-2,4-toluenediamine, and 3,5-diethyl-2,6-toluenediamine, and primary mono-, di-, tri-, or tetraalkyl-substituted 4,4′-diaminodiphenylmethanes. A particularly preferred anti-settling agent is diethyltoluenediamine.

In certain embodiments, the anti-settling agent is present in the formulation of the invention in an amount of up to 5% by weight, based on the weight of the formulation. In other embodiments, the anti-settling agent is present in the formulation of the invention in an amount of from 0.5% to 1% by weight, based on the weight of the formulation. The anti-settling agent may be present in the formulation of the invention in an amount ranging between any combination of these values, inclusive of the recited values.

### Examples

The non-limiting and non-exhaustive examples that follow are intended to further describe various non-limiting and non-exhaustive embodiments without restricting the scope of the embodiments described in this specification.

| | |
|---|---|
| ANTI-SETTLING | diethyltoluenediamine (DETDA), |
| AGENT A | commercially available from Covestro as |
| | BAYTEC 505; |
| ANTI-SETTLING | a non-reactive polyamide thixotropic |
| AGENT B | agent, commercially available from King |
| | Industries, Inc. as DISPARLON 6500; |
| CURING AGENT | an amine functional curing agent, commercially |
| A | available from Albemarle Corp. as ETHACURE |
| | 100-LC CURATIVE; |
| DEFOAMER A | a polysiloxane based defoamer, commercially |
| | available from Enterprise Specialty Products |
| | Inc. as FC 983; |
| DEFOAMER B | a VOC-free silicone-containing defoamer for |
| | aqueous emulsion lacquers, printing inks, |
| | overprint varnishes, and emulsion adhesives, |
| | commercially available from BYK Chemie as |
| | BYK-024; |
| ISOCYANATE A | a polyfunctional aliphatic isocyanate resin based |
| | on hexamethylene diisocyanate (HDI) having an |
| | NCO content of 19.5 ± 0.5% and a viscosity of |
| | 450 ± 150 mPa · s @ 25° C. commercially |
| | available from Covestro as DESMODUR XP- |
| | 2580; |
| POLYOL A | a polypropylene oxide-based diol; hydroxyl |
| | number 495-535 mg KOH/g; specific gravity at |
| | 25° C. of 1.02, commercially available from |
| | Covestro as MULTRANOL 9198; |
| POLYOL B | a castor oil polyol, having an OH number of 254 |
| | and a viscosity @ 25° C. of 350 cP, commercially |
| | available from Vertellus Performance Materials |
| | Inc. as CASPOL 5007; |
| POLYOL C | a castor oil based polyol having an OH number |
| | of 140 and a viscosity @ 25° C. of 650 cP, |
| | commercially available from Vertellus |
| | Performance Materials Inc. as POLYCIN D-140; |
| POLYOL D | a castor oil based polyol having OH number of |
| | 496 and a viscosity @ 25° C. of 205 cP, |
| | commercially available from Vertellus |
| | Performance Materials Inc. as POLYCIN XP |
| | 100LV; |
| POLYOL E | a castor oil based polyol having OH number of |
| | 479 and a viscosity @ 25° C. of 175 cP, |
| | commercially available from Vertellus |
| | Performance Materials Inc. as POLYCIN XP |
| | 200LV; and |
| WEIGHTING | barium sulfate (BaSO₄) commercially available |
| AGENT A | from Cimbar Performance Materials as |
| | CIMWATE 200. |

Formulations 1-9 were prepared by mixing the components in the amounts listed in Table I (amounts are normalized to 100 by weight) for 60 sec. at 3000 rpm and allowing the mixture to stand in a beaker. The anti-settling agent was blended with the polyol-containing component prior to mixing the polyol-containing component with the polyisocyanate-containing component. The percentages of anti-settling agent given in Table I are the final concentrations of anti-settling agent in the formulations. The formulations were evaluated for gel time at 200° F. (93.3° C.) and the times are given in Table I. Gel time was determined by using a GARDCO GT-SHP “Hot Pot” Gel Timer. 100 grams of the formulation was poured into an aluminum cup and placed into the “hot pot” of the gel timer that had already been stable at the cure temperature. The gel timer had a motor that rotated a stirrer that was inserted in the formulation. As gelation occurred, drag eventually exceeded torque and the motor stalled. The time at which the motor stalled was the reported gel time.

TABLE I

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Component 1 | | | | | | | | | |
| POLYOL A | | | | | 17.25 | 17.05 | 16.85 | 17.20 | 17.20 |
| POLYOL B | | 49.28 | | | | | | | |
| POLYOL C | 63.80 | | | | | | | | |
| POLYOL D | | | 33.22 | | | | | | |
| POLYOL E | | | | 33.22 | | | | | |
| WEIGHTING AGENT A | | | | | 48.45 | 48.43 | 48.43 | 48.30 | 48.30 |
| CURING AGENT A | | | | | | 0.17 | 0.34 | | |
| DEFOAMER A | | | | | | 0.05 | 0.05 | | 0.05 |
| DEFOAMER B | | | | | | | | 0.05 | |
| Component 2 | | | | | | | | | |
| ISOCYANATE A | 36.20 | 50.72 | 66.78 | 66.78 | 34.29 | 34.30 | 34.32 | 34.19 | 34.19 |
| Mix Ratio (volume) | 2.06:1 | 1.12:1 | 0.57:1 | 0.57:1 | 0.87:1 | 0.87:1 | 0.87:1 | 0.88:1 | 0.88:1 |
| NCO:OH | 1.05 | 1.05 | 1.05 | 1.05 | 1.00 | 1.00 | 1.00 | 1.00 | 1.00 |
| P/B | 0 | 0 | 0 | 0 | 0.94 | 0.94 | 0.94 | 0.94 | 0.94 |
| PVC | 0 | 0 | 0 | 0 | 17.10 | 17.11 | 17.11 | 17.10 | 17.10 |
| VOC | 0 | 0 | 0 | 0 | 0 | 0 | 0 | 0 | 0 |
| Volume Solids | 100.00 | 100.00 | 100.00 | 100.00 | 100.00 | 100.00 | 100.00 | 100.00 | 100.00 |
| Weight Solids | 100.00 | 100.00 | 100.00 | 100.00 | 100.00 | 100.00 | 100.00 | 100.00 | 100.00 |
| Wt/Gal | 8.40 | 8.67 | 8.90 | 8.90 | 14.51 | 14.50 | 14.50 | 14.47 | 14.47 |
| ANTI-SETTLING AGENT A | | 1.0% | 1.0% | | | 1.0% | 1.0% | | |
| ANTI-SETTLING AGENT B | | | | 0.5% | | | | 0.5% | 0.5% |
| Gel time (minutes) | 117 | 47.75 | 18.5 | 17.25 | 338.25 | 258.5 | | | 318 |

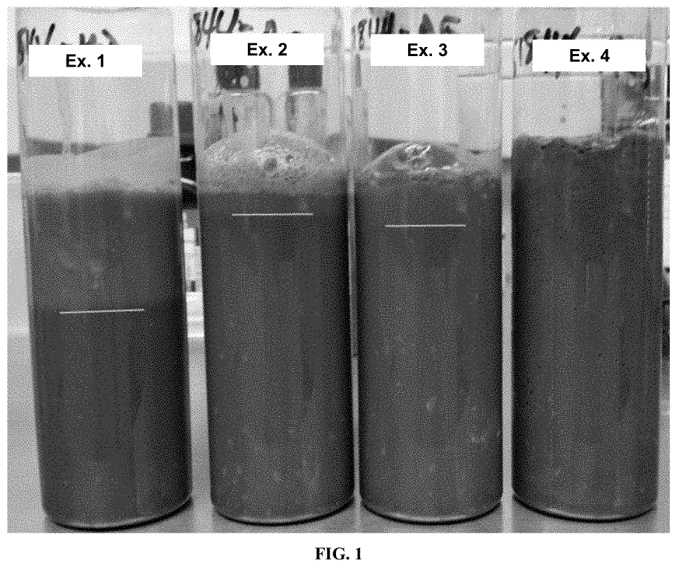

FIG. 1 is a photograph of the formulations of Ex. 1, Ex. 2, Ex. 3, and Ex. 4, all after 16 hours at 120° F. (48.9° C.). The formulation Ex. 4, made with the amide-containing anti-settling agent (ANTI-SETTLING AGENT B) exhibited additional foaming after heat aging of the formulation.

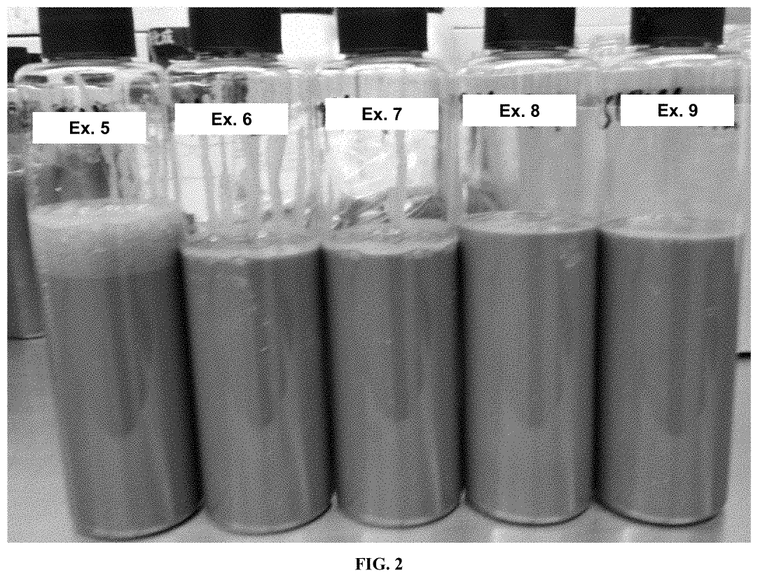

FIG. 2 is a photograph showing initial views of the formulations of Ex. 5, Ex. 6, Ex. 7, Ex. 8, and Ex. 9.

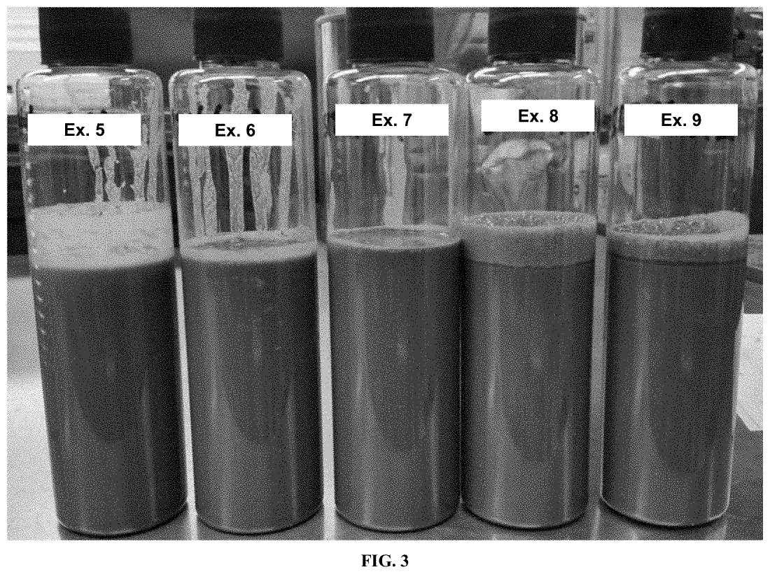

FIG. 3 is a photograph showing the formulations of Ex. 5, Ex. 6, Ex. 7, Ex. 8, and Ex. 9, all after two hours at 120° F. (48.9° C.).

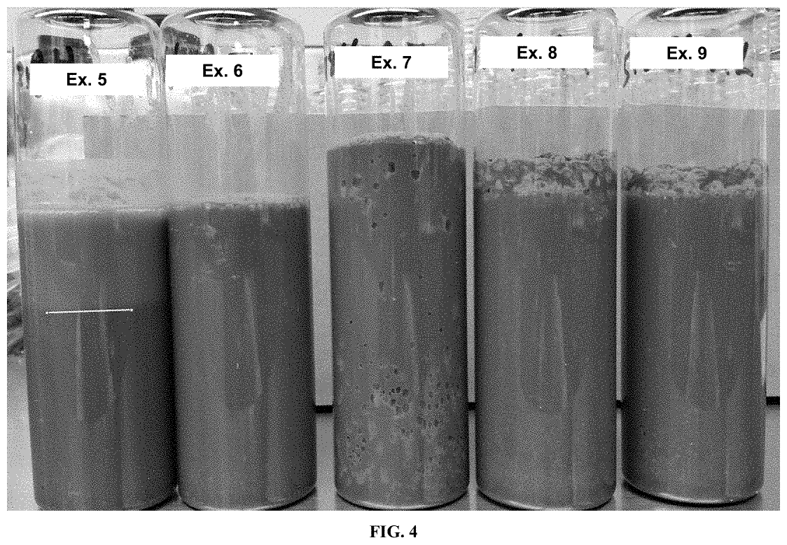

FIG. 4 is a photograph showing the formulations of Ex. 5, Ex. 6, Ex. 7, Ex. 8, and Ex. 9, all after 16 hours at 120° F. (48.9° C.). The formulations containing the amide-containing anti-settling agent (ANTI-SETTLING AGENT B), i.e., Ex., 8, and Ex. 9, exhibited additional foaming after heat aging of the formulations.

The inventive formulation may provide improved drilling fluids, coatings, sealants, adhesives, composites, and films because the anti-settling agent reduces both stratification and foaming seen during mixing with conventional anti-settling agents.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. A formulation comprising: a) a polyol-containing component; b) a weighting agent or a pigment; c) an anti-settling agent selected from the group consisting of primary amines and secondary amines; and d) a polyisocyanate-containing component, wherein the anti-settling agent reduces foam formation during mixing of the formulation as compared to the formulation not containing the anti-settling agent.

Clause 2. The formulation according to Clause 1, wherein the anti-settling agent is selected from the group consisting of ethylenediamine, 1,2-propylenediamine, 1,3-propylenediamine, N-methylpropylene-1,3-diamine, N,N′-dimethylethylenediamine, isophoronediamine, 2,4-toluenediamine and 2,6-toluenediamine, 3,5-diethyl-2,4-toluenediamine, and 3,5-diethyl-2,6-toluenediamine, and primary mono-, di-, tri-, or tetraalkyl-substituted 4,4′-diaminodiphenylmethanes.

Clause 3. The formulation according to one of Clauses 1 and 2, wherein the anti-settling agent is diethyltoluenediamine (DETDA).

Clause 4. The formulation according to any one of Clauses 1 to 3, wherein the weighting agent is selected from the group consisting of barite (BaSO₄), hematite (Fe₂O₃), siderite (FeCO₃), ilmentite (FeO.TiO₂), magnetite (Fe₃O₄), hausmannite (Mn₃O₄), galena (PbS), calcite (CaCO₃), celestine (SrSO₄), halite (NaCl), and dolomite (CaMg(CO₃)₂).

Clause 5. The formulation according to any one of Clauses 1 to 4, wherein the weighting agent is barite (BaSO₄).

Clause 6. The formulation according to any one of Clauses 1 to 3, wherein the pigment is selected from the group consisting of inorganic white pigments, inorganic chromatic pigments, iron oxide pigments, oxidic mixed-phase pigments, organic pigments, and inorganic black pigments.

Clause 7. The formulation according to any one of Clauses 1 to 6, wherein the polyisocyanate-containing component comprises one selected from the group consisting of ethylene diisocyanate; 1,4-tetramethylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, benzene diisocyanate; 1,4-cyclohexylene diisocyanate, 1,12-dodecamethylene diisocyanate, 1,4-phenylene diisocyanate, 2,4- and/or 2,6-toluene diisocyanate (TDI) or hydrogenated 2,4- and/or 2,6-toluene diisocyanate, 1,5-naphthalene diisocyanate, 2,4′- and 4,4′-diphenylmethane diisocyanate (MDI), 1,3- and 1,4-bis-(2-isocyanato-prop-2-yl)-benzene (TMXDI), 1,3-bis(isocyanato-methyl)benzene (XDI), bis-(4-isocyanato-cyclohexyl)methane (H12MDI), (S)-alkyl 2,6-diisocyanato-hexanoates or (L)-alkyl 2,6-diisocyanatohexanoates, 4-isocyanatomethyl-1,8-octane diisocyanate (triisocyanatononane or TIN), and isomers or derivatives of any of these

Clause 8. The formulation according to any one of Clauses 1 to 7, wherein the polyol-containing component comprises one selected from the group consisting of polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, and polyester polycarbonate polyols.

Clause 9. A drilling fluid comprising the formulation according to any one of Clauses 1 to 8.

Clause 10. One of a coating, a sealant, an adhesive, a composite, a lost circulation material, a zonal isolation agent, and a film, including the formulation according to any one of Clauses 1 to 8.

Clause 11. A method of reducing foaming of a formulation, the method comprising: a) preparing a formulation by combining, (1) a polyol-containing component, (2) a weighting agent or a pigment, (3) an anti-settling agent selected from the group consisting of primary amines and secondary amines, and (4) a polyisocyanate-containing component; and b) mixing the formulation, wherein the anti-settling agent reduces foaming during mixing as compared to the formulation not containing the anti-settling agent.

Clause 12. The method according to Clause 11, wherein the anti-settling agent is selected from the group consisting of ethylenediamine, 1,2-propylenediamine, 1,3-propylenediamine, N-methylpropylene-1,3-diamine, N,N′-dimethylethylenediamine, isophoronediamine, 2,4-toluenediamine and 2,6-toluenediamine, 3,5-diethyl-2,4-toluenediamine, and 3,5-diethyl-2,6-toluenediamine, and primary mono-, di-, tri-, or tetraalkyl-substituted 4,4′-diaminodiphenylmethanes.

Clause 13. The method according to one of Clauses 11 and 12, wherein the anti-settling agent is diethyltoluenediamine (DETDA).

Clause 14. The method according to any one of Clauses 11 to 13, wherein the weighting agent is selected from the group consisting of barite (BaSO₄), hematite (Fe₂O₃), siderite (FeCO₃), ilmentite (FeO.TiO₂), magnetite (Fe₃O₄), hausmannite (Mn₃O₄), galena (PbS), calcite (CaCO₃), celestine (SrSO₄), halite (NaCl), and dolomite (CaMg(CO₃)₂).

Clause 15. The method according to any one of Clauses 11 to 14, wherein the weighting agent is barite (BaSO₄).

Clause 16. The method according to any one of Clauses 11 to 13, wherein the pigment is selected from the group consisting of inorganic white pigments, inorganic chromatic pigments, iron oxide pigments, oxidic mixed-phase pigments, organic pigments, and inorganic black pigments.

Clause 17. The method according to any one of Clauses 11 to 16, wherein the polyisocyanate-containing component comprises one selected from the group consisting of ethylene diisocyanate; 1,4-tetramethylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, benzene diisocyanate; 1,4-cyclohexylene diisocyanate, 1,12-dodecamethylene diisocyanate, 1,4-phenylene diisocyanate, 2,4- and/or 2,6-toluene diisocyanate (TDI) or hydrogenated 2,4- and/or 2,6-toluene diisocyanate, 1,5-naphthalene diisocyanate, 2,4′- and 4,4′-diphenylmethane diisocyanate (MDI), 1,3- and 1,4-bis-(2-isocyanato-prop-2-yl)-benzene (TMXDI), 1,3-bis(isocyanato-methyl)benzene (XDI), bis-(4-isocyanato-cyclohexyl)methane (H12MDI), (S)-alkyl 2,6-diisocyanato-hexanoates or (L)-alkyl 2,6-diisocyanatohexanoates, 4-isocyanatomethyl-1,8-octane diisocyanate (triisocyanatononane or TIN), and isomers or derivatives of any of these.

Clause 18. The method according to any one of Clauses 11 to 17, wherein the polyol-containing component comprises one selected from the group consisting of polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, and polyester polycarbonate polyols.

Clause 19. A drilling fluid comprising the formulation made according to the method of any one of Clauses 11 to 18.

Clause 20. One of a coating, a sealant, an adhesive, a composite, a lost circulation material, a zonal isolation agent, and a film, including the formulation made according to the method of any one of Clauses 11 to 18.

Clause 21. A method of treating an underground geologic formation comprising: (a) introducing the formulation according to one of Clauses 1 to 8 into the formation; (b) forcing the formulation into pores of the formation under sufficient pressure and for a sufficient time such that the polyol-containing component and the polyisocyanate-containing component react to form a solid polyurethane reaction product that seals the existing perforations and associated fractures of the formation to reduce or prevent water ingress; and (c) forcing a slurry comprising a plurality of proppant particles suspended in a carrier fluid into the formation under sufficient pressure and for a sufficient time such that new fissures and cracks are formed in the formation.

Clause 22. An oil and gas well treatment comprising: introducing the formulation according to one of Clauses 1 to 8 into a well bore, wherein the formulation solidifies and reduces or prevents ingress of formation water into the oil and gas well.

What is claimed is:

1. A formulation comprising:
a) a polyol-containing component;
b) a weighting agent or a pigment;
c) an anti-settling agent selected from the group consisting of primary amines and secondary amines; and
d) a polyisocyanate-containing component,
wherein the anti-settling agent reduces foam formation during mixing of the formulation as compared to the formulation not containing the anti-settling agent.

2. The formulation according to claim 1, wherein the anti-settling agent is selected from the group consisting of ethylenediamine, 1,2-propylenediamine, 1,3-propylenediamine, N-methylpropylene-1,3-diamine, N,N′-dimethylethylenediamine, isophoronediamine, 2,4-toluenediamine and 2,6-toluenediamine, 3,5-diethyl-2,4-toluenediamine, and 3,5-diethyl-2,6-toluenediamine, and primary mono-, di-, tri-, or tetraalkyl-substituted 4,4′-diaminodiphenylmethanes.

3. The formulation according to claim 1, wherein the anti-settling agent is diethyltoluenediamine (DETDA).

4. The formulation according to claim 1, wherein the weighting agent is selected from the group consisting of barite (BaSO₄), hematite (Fe₂O₃), siderite (FeCO₃), ilmentite (FeO.TiO₂), magnetite (Fe₃O₄), hausmannite (Mn₃O₄), galena (PbS), calcite (CaCO₃), celestine (SrSO₄), halite (NaCl), and dolomite (CaMg(CO₃)₂).

5. The formulation according to claim 1, wherein the weighting agent is barite (BaSO₄).

6. The formulation according to claim 1, wherein the pigment is selected from the group consisting of inorganic white pigments, inorganic chromatic pigments, iron oxide pigments, oxidic mixed-phase pigments, organic pigments, and inorganic black pigments.

7. The formulation according to claim 1, wherein the polyisocyanate-containing component comprises one selected from the group consisting of ethylene diisocyanate; 1,4-tetramethylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, benzene diisocyanate; 1,4-cyclohexylene diisocyanate, 1,12-dodecamethylene diisocyanate, 1,4-phenylene diisocyanate, 2,4- and/or 2,6-toluene diisocyanate (TDI) or hydrogenated 2,4- and/or 2,6-toluene diisocyanate, 1,5-naphthalene diisocyanate, 2,4′- and 4,4′-diphenylmethane diisocyanate (MDI), 1,3- and 1,4-bis-(2-isocyanato-prop-2-yl)-benzene (TMXDI), 1,3-bis(isocyanato-methyl)benzene (XDI), bis-(4-isocyanato-cyclohexyl)methane (H12MDI), (S)-alkyl 2,6-diisocyanato-hexanoates or (L)-alkyl 2,6-diisocyanatohexanoates, 4-isocyanatomethyl-1,8-octane diisocyanate (triisocyanatononane or TIN), and isomers or derivatives of any of these

8. The formulation according to claim 1, wherein the polyol-containing component comprises one selected from the group consisting of polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, and polyester polycarbonate polyols.

9. A drilling fluid comprising the formulation according to claim 1.

10. One of a coating, a sealant, an adhesive, a composite, a lost circulation material, a zonal isolation agent, and a film, including the formulation according to claim 1.

11. A method of reducing foaming of a formulation, the method comprising:
a) preparing a formulation by combining,
(1) a polyol-containing component,
(2) a weighting agent or a pigment,
(3) an anti-settling agent selected from the group consisting of primary amines and secondary amines, and
(4) a polyisocyanate-containing component; and
b) mixing the formulation,
wherein the anti-settling agent reduces foaming during mixing as compared to the formulation not containing the anti-settling agent.

12. The method according to claim 11, wherein the anti-settling agent is selected from the group consisting of ethylenediamine, 1,2-propylenediamine, 1,3-propylenediamine, N-methylpropylene-1,3-diamine, N,N′-dimethylethylenediamine, isophoronediamine, 2,4-toluenediamine and 2,6-toluenediamine, 3,5-diethyl-2,4-toluenediamine, and 3,5-diethyl-2,6-toluenediamine, and primary mono-, di-, tri-, or tetraalkyl-substituted 4,4′-diaminodiphenylmethanes.

13. The method according to claim 11, wherein the anti-settling agent is diethyltoluenediamine (DETDA).

14. The method according to claim 11, wherein the weighting agent is selected from the group consisting of barite (BaSO₄), hematite (Fe₂O₃), siderite (FeCO₃), ilmentite (FeO.TiO₂), magnetite (Fe₃O₄), hausmannite (Mn₃O₄), galena (PbS), calcite (CaCO₃), celestine (SrSO₄), halite (NaCl), and dolomite (CaMg(CO₃)₂).

15. The method according to claim 11, wherein the weighting agent is barite (BaSO₄).

16. The method according to claim 11, wherein the pigment is selected from the group consisting of inorganic white pigments, inorganic chromatic pigments, iron oxide pigments, oxidic mixed-phase pigments, organic pigments, and inorganic black pigments.

17. The method according to claim 11, wherein the polyisocyanate-containing component comprises one selected from the group consisting of ethylene diisocyanate; 1,4-tetramethylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, benzene diisocyanate; 1,4-cyclohexylene diisocyanate, 1,12-dodecamethylene diisocyanate, 1,4-phenylene diisocyanate, 2,4- and/or 2,6-toluene diisocyanate (TDI) or hydrogenated 2,4- and/or 2,6-toluene diisocyanate, 1,5-naphthalene diisocyanate, 2,4′- and 4,4′-diphenylmethane diisocyanate (MDI), 1,3- and 1,4-bis-(2-isocyanato-prop-2-yl)-benzene (TMXDI), 1,3-bis(isocyanato-methyl)benzene (XDI), bis-(4-isocyanato-cyclohexyl)methane (H12MDI), (S)-alkyl 2,6-diisocyanato-hexanoates or (L)-alkyl 2,6-diisocyanatohexanoates, 4-isocyanatomethyl-1,8-octane diisocyanate (triisocyanatononane or TIN), and isomers or derivatives of any of these.

18. The method according to claim 11, wherein the polyol-containing component comprises one selected from the group consisting of polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, and polyester polycarbonate polyols.

19. A drilling fluid comprising the formulation made according to the method of claim 11.

20. One of a coating, a sealant, an adhesive, a composite, a lost circulation material, a zonal isolation agent, and a film, including the formulation made according to the method of claim 11.
